(19) United States
(12) Patent Application Publication
(10) Pub. No.: US 2012/0233246 A1
(43) Pub. Date: Sep. 13, 2012

(54) SAFETY SYSTEM FOR TAXI USERS COMBINING REPUTATION MECHANISMS AND COMMUNITY NOTIFICATIONS

(76) Inventor: Emilio Guemez, La Jolla, CA (US)

(21) Appl. No.: 13/230,632

(22) Filed: Sep. 12, 2011

Related U.S. Application Data
(60) Provisional application No. 61/381,570, filed on Sep. 10, 2010.

(51) Int. Cl. G06F 15/16

(52) U.S. Cl. 709/203

(57) ABSTRACT

Disclosed is an safety system for taxicab users including (a) mechanisms for profiling the reputation (including reputations of service-quality and safety) of a taxicab and/or taxi-driver and (b) mechanisms for community notification of the taxicab and driver profiles.

### CROSS-REFERENCE TO RELATED APPLICATIONS

This application claims the benefit and priority of U.S. Prov. Pat. App. Ser. No. 61/381,570 (filed on Sep. 10, 2010) entitled “Safety System for Taxi Users Combining Reputation Mechanisms and Community Notifications,” which document is hereby incorporated by reference in its entirety.

### STATEMENT REGARDING FEDERALLY SPONSORED RESEARCH OR DEVELOPMENT

Not Applicable.

### BACKGROUND OF THE INVENTION

1. Field of Invention

This specification is in the field of Taxicab safety systems.

2. Background.

Taxicabs are well-known transportation vehicles, operated by a taxi-driver, for hire which conveys passengers (“Taxi Users”) between pick-up and drop-off locations selected by the passenger. Historically, taxicabs have frequently been hailed or met by one or more passengers at a pick-up location whereafter the passengers are conveyed to the drop-off location. Taxi-fare, the fee for the taxi-service, may be dependent on the distance and/or time duration between the pick-up and drop-off locations and sometimes is paid to the taxi-driver at the drop-location.

Although universally adopted as a mode of transportation, historically known taxicabs have not been entirely satisfactory for conveying passengers between pick-up and drop-off locations. One unsatisfactory aspect of known public hire taxicabs is that the passengers have few means for assessing the safety of a hailed or hired taxicab. Most frequently, taxi-passengers have either (a) assumed the safety of the taxicab or (b) hastily and subjectively judged the safety of the hailed taxicab in view of its appearances or its driver's unsubstantiated assurances. Therefore, there is a need for a system which allows taxicab passengers to quickly and objectively assess the safety or reputation of a hailed taxicab.

Another unsatisfactory aspect of historical taxicabs is that passengers have limited recourse against malfeasance involving the taxicab. For example, robberies or assaults by taxi-drivers toward their passengers or by non-driver criminals towards passengers are known to occur and, in many of such incidents, passengers have only relied on their memory of the incident, which frequently is stressed by the incident, to remember details or information upon which recourse depends (e.g., mistreated passengers may not accurately remember the taxicab's license plate number so that the driver may be more readily apprehended or identified). For another example, taxi-passenger kidnappings by either a taxi-driver or a non-driver criminal are known to occur and investigators of the kidnapping cannot readily determine (1) that the victim was a taxicab passenger and (2) whether the victim arrived at a drop-off location. Accordingly, there is also a need for a system which allows taxicab passengers and investigators to quickly and objectively identify details or information concerning a passenger and his or her hired taxicab.

Relatedly, another unsatisfactory aspect of historically known public hire taxicabs is that minor (i.e., under the age of 18) taxi-passengers riding solo may incorrectly identify a drop-off location so that the passenger and his/her guardian are unsure of the passenger's whereabouts. As a result, there is a further need for a system which allows taxicab passengers and investigators to quickly and objectively identify details or information concerning a hired taxicab.

### SUMMARY OF THE INVENTION

In view of the forgoing it is an object of this specification to disclose a system for use by taxicab passengers, which system meets the above identified needs. In one preferred embodiment, the system may combine (a) mechanisms for profiling the reputation (including reputations of service-quality and safety) of a taxicab and/or taxi-driver and (b) mechanisms for community notification of the taxicab and driver profiles. In one embodiment, a taxicab passenger inputs location data and the license plate number (and possibly other taxicab information or information about the driver) of a hailed taxicab into a system via a device at the hail location, wherein the system features databases of taxicab information, including ownership, accident, incident, and service rating records, and wherein the system (i) communicates some of the information to the passenger's device so that the passenger may make an informed decision about hiring the taxicab and (ii) posts some of the location and taxicab information to one of a Social Network APIs, Micro Blogging service, Short Message Service (SMS) transit, or Mail Server of the passenger's choosing. If the passenger hires the taxicab, the passenger may be provided with an emergency alert option on the device so that the system may notify private or public security institutions of an emergency and provide such institutions with taxicab and location information in the event of an emergency. Such a system may have one or more of the following advantages: (1) passengers may more easily assess the safety of a taxicab; (2) passengers may have more means for quickly and objectively analyzing the safety of a hailed taxicab and its driver; (3) investigators may have more means for identifying details and information about a hailed taxicab involved in a malfeasant event; and, (4) passenger guardians may have more means for identifying the whereabouts of a passenger.

### BRIEF DESCRIPTION OF THE FIGURES

The manner in which these objectives and other desirable characteristics can be obtained is better explained in the following description and attached figures in which:

FIG. 1 is a diagram providing a general overview of a Safety System for Taxi Users combining reputation mechanisms and community notifications;

FIG. 2 is a flowchart diagram depicting an embodiment of the workflow of the system of FIG. 1 that a Taxi User may follow when interacting with the System;

FIG. 3 is a flowchart depicting a typical flow that a Taxi User may follow to configure the notifications to be sent when the Taxi User communicates to the Reputation and Notification Servers 14 that a Taxi has been hired;

FIG. 4 shows the information that the Taxi User may communicate to the Reputation and Notification Servers 14 in order to get relevant information about the Taxi in question;

FIG. 5a shows information the Reputation and Notification Servers 14 may communicate to a Taxi User regarding the official incidents records associated with the license plate of the Taxi;

FIG. 5b shows information the Reputation and Notification Servers 14 may communicate to a Taxi User regarding community feedback associated with the license plate of the Taxi;

FIG. 5c shows information the Reputation and Notification Servers 14 may communicate to a Taxi User stating if the Taxicab License Plate belongs to an officially authorized Taxicab, as well as details about the maker, model and year of the car that is associated with the Taxicab License Plate;

FIG. 6 shows information the Taxi User may communicate to the Reputation and Notification Servers 14 in order to confirm that the Taxi User has hired the Taxicab;

FIG. 7 shows information the Taxi User 40 may communicate to the Reputation and Notification Servers 14 in order to rate the quality of service that the Taxi User has received from the Taxicab 31; and,

FIG. 8 is a flowchart depicting a typical flow that may be followed when a registered Taxi User 40 communicates an emergency alert notice to the Reputation and Notification Servers 14.

In the figures, like reference numerals designate corresponding parts throughout the different illustrations. In the figures, the numerals generally designate the following:
10 Web Application;
12 Social Network API;
14 Reputation and Notification Servers;
16 Mobile Application;
18 Security Institution;
20 SMS enabled mobile device;
22 SMS Gateway;
24 Email message;
26 Mail Server;
27 Alert Operator;
29 Taxi Driver;
30 Database containing official license plate numbers of taxis, registered with the Reputation Service;
31 Taxicab;
32 Database with official information regarding traffic violations, robberies, abuses and other incidents;
33 Taxicab License Plate;
35 Network;
36 Micro Blogging API;
37 Stand Alone Application;
38 Database of user generated evaluations; and,
40 Taxi User, a person intending to use the Taxicab Service

It is to be noted, however, that the appended figures illustrate only a typical embodiment disclosed in this application, and therefore, are not to be considered limiting of the scope of invention principles, for the invention principles disclosed herein may admit to other equally effective embodiments that will be appreciated by those reasonably skilled in the relevant arts.

### DETAILED DESCRIPTION OF PREFERRED EMBODIMENTS

The disclosed system may allow a user to obtain reputation and security information about a Taxicab. The system may incorporate a system for notifying other people when a person has hired a Taxicab. The system may incorporate an alert that notifies other people or institutions that a Taxi User (i.e., taxicab passenger) needs help or assistance. The system may also incorporate a system for rating taxi service providers. This rating system may give users more information to determine the security and quality of service of a Taxi that the user may decide to take.

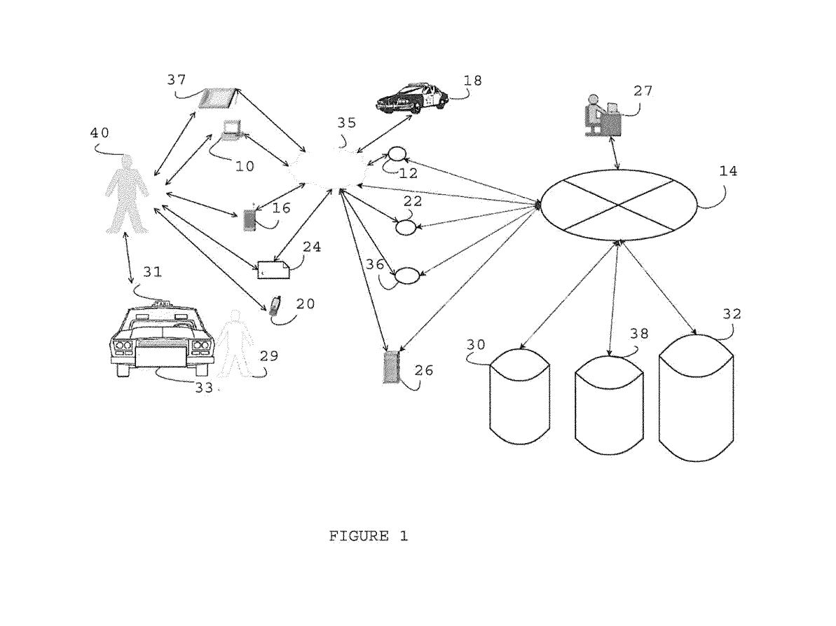

FIG. 1 shows a simplified diagram providing a general overview of a Safety System for Taxi Users combining reputation mechanisms and community notifications. As seen in the figure, a Taxi Users 40 (of a taxicab 31 driven by a taxi driver 29) may use either a web application 10, standalone application 37, mobile application 16, email 24 or an SMS enabled phone 20 or any combination thereof, to communicate to a Reputation and Notification Servers 14 (with an Alert Operator 27 for receiving and emergency notifications from the user 40), via a network 35. In addition to communications with the client applications or electronic devices, the Reputation and Notification servers 14 may communicate with Social Network APIs 12, Micro Blogging services 36, Short Message Service (SMS) transit 22, or Mail Servers 26.

The Reputation and Notification Servers 14 may include one or more of the following: an application server, a data source, such as a database server, a middleware server, web services server. The Reputation and Notification Servers 14 servers may co-exist on one machine or may be running in a distributed configuration on one or more machines. The Reputation and Notification Servers 14 may collectively be referred to as the server. Within the Reputation and Notification Servers 14, there may be several configurations of email servers, database servers, application servers, web services server and middleware servers. Database servers may include MICROSOFT SQL SERVER, ORACLE, IBM DB2, MySQL or any other database software, relational or otherwise. The application server may be APACHE TOMCAT, MICROSOFT IIS, ADOBE COLDFUSION, or any other application server that supports communication protocols. The middleware server may be any middleware that connects software components or applications. The Web Services Server may integrate with .NET, J2EE, CICS, SAP or any other Web services-enabled platforms. The Web Services Server may support REST type architectures and support RESTful implementation such as the Web and can use standards like HTTP, URL, XML, PNG among others. The Web Services Server may use SOAP or any other protocol specification for exchanging information in the implementation of Web Services in computer networks.

The network 35 may include wide area networks (WAN), such as the Internet, local area networks (LAN), campus area networks, metropolitan area networks, or any other networks known to those of skill in the art that may allow for data communication. The Reputation and Notification Servers 14 may communicate to the Taxi Users 14 via the network 40, through the web applications 10, standalone applications 37, email 24, mobile applications 16 or an SMS enabled phone 20.

The web application 10, standalone application 37, mobile application 16, email 24 or and SMS enabled phone 20 may be connected to the network 35 in any configuration that supports data transfer. This may include a data connection to the network 35 that may be wired or wireless. Any of the web applications 10, standalone applications 37, mobile applications 16, and SMS enabled phone 20 may individually be referred to as a client application or electronic device. The web applications 10 may run on any platform that supports web content, such as a web browser or a computer, a mobile phone, or any appliance capable of data communications.

The standalone applications 37 may run on a machine that may have a processor, a memory, a display, and an interface. The processor may be operatively connected to the memory, display and the interface and may perform tasks at the request of the standalone applications 37 or the underlying operating system, such as communicating Taxi License Plate 33 information. The memory may be capable of storing data. The display may be operatively connected to the memory and the processor and may be capable of displaying information to the Taxi User 40. The interface may be operatively connected to the memory, the processor, and the display. The standalone applications 37 may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others. The standalone applications 37 may be third-party standalone applications or may be third-party servers.

The mobile applications 16 may run on any mobile device that may have a data connection. The data connection may be a cellular connection, a wireless date connection, an Internet connection, an infrared connection, a Bluetooth connection, or any other connection capable of transmitting data.

The SMS enabled phone 20 may be any mobile device that may support SMS data connection. The data connection may be a cellular connection, a wireless date connection, an Internet connection, an infrared connection, a Bluetooth connection, or any other connection capable of transmitting data in the SMS format.

The Reputation and Notification Servers 14 may communicate with Social Networks by using the Social Network application programming interface (API) 12, which is an interface implemented by a software program that may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others, and may enable the Reputation and Notification Servers 14 to interact with the Social Networks. The Social Networks, or which a Social Network application programming interface (API) is used, may include Facebook, MySpace, Hi5, LinkedIn, Orkut, Tuenti or any other online service, platform, or site that focuses on building and reflecting social networks or social relations among people.

The Reputation and Notification Servers 14 may communicate with a Social Network API that has been implemented by different applications, libraries, and operating systems, which may include specifications for routines, data structures, object classes, and protocols used to communicate between the Reputation and Notification Servers 14 and the Social Network API.

The Reputation and Notification Servers 14 communicate with Micro Blogging services by using the Micro Blogging application-programming interface (API) 36, which is an interface implemented by a software program that may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others, and may enable the Reputation and Notification Servers 14 to interact with Micro Blogging Services. The Micro Blogging services for which a Micro Blogging application programming interface (API) 36 is used, may include Twitter, Tumblr, Posterous, Dailybooth, Google Buzz or any other site that is a passive broadcast medium in the form of blogging.

The Micro Blogging API supports alternative ways of publishing entries including but not limited to web-based interface, text messaging, instant messaging, E-mail, digital audio, digital video.

The Reputation and Notification Server 14 may communicate with a Micro Blogging API 36 that has been implemented by different applications, libraries, and operating systems, which may include specifications for routines, data structures, object classes, and protocols used to communicate between the Reputation and Notification Servers 14 and the Social Network API.

The SMS gateway 22 provides the Reputation and Notification Servers 14 with a service of offering Short Message Service (SMS) transit, transforming messages to mobile network traffic from other media, or vice versa, and thus allowing the Reputation and Notification Servers to perform the transmission or receipt of SMS messages.

In order to send and receive email messages 24, the Reputation and Notification Servers 14 communicates with the Mail Server 26 that may be a program, application or a computer capable of receiving incoming email and forwarding outgoing e-mail for delivery. The Mail Server may be Microsoft Exchange, gmail, Exim, sendmail or any other program or application capable of receiving incoming e-mal and forwarding outgoing emails for delivery.

For sending e-mails, the Mail Server 26 may use SMTP (Simple Mail Transfer Protocol), ESMTP (extended SMTP) or any other protocol that supports sending emails. For receiving e-mails, the Mail Server 26 may use POP3 (Post Office Protocol 3), IMAP (Internet Message Access Protocol) or any other protocol that supports receiving emails.

The Alert Operator 27 is a person, who interacts with the Reputation and Notification Server 14 through a graphical user interface that notifies the Alert Operator when the Taxi User 40 may be experiencing an emergency. The Alert Operator 27 communicates with the Taxi User 40 via the Reputation and Notification Server 14 and may contact the Taxi User 40 through a web applications 10, standalone applications 37, mobile applications 16, SMS enabled phone 20 or any combination of these, via the Network 35 to verify the existence of an emergency. In case of a verified emergency, the Alert Operator 27 communicates via the Network 35 with private or government security institutions 18 to alert them of an emergency.

The Taxicab 31 is a type of vehicle for hire, with a driver 29, for a single passenger, or small group of passengers, for a shared or non-shared ride. A Taxicab 31 conveys passengers between locations of their choice. When referring to a Taxicab 31 it may be any of the following four distinct forms of Taxicab 31: Hackney Carriage, also known as public hire, hailed or street taxis, available for hire and reward and for hailing on street; Private Hire Vehicles (PHVs), also known as minicabs, Taxi buses, also known as Jitneys, operating on pre-set routes for hire and reward, typified by multiple stops and multiple independent passengers; and Limousines, specialized vehicle licensed for operation by pre-booking.

Still referring to FIG. 1, the Reputation and Notification Servers 14 may communicate with various databases to retrieve information regarding the taxicab 31 or its driver 29. Preferably, the Reputation and Notification Servers 14 may communicate with a Database 30, which has official license plate numbers of registered taxis to confirm if a Taxicab 31 with a Taxicab License Plate 33 belongs to an officially licensed vehicle. Suitably, the Reputation and Notification Servers 14 may obtain relevant information regarding traffic violations, robberies, abuses and other incidents associated with the Taxicab License Plate 33 or driver 29, via communicating with another Database 32, which has been populated with official information about such events. Furthermore, the Reputation and Notification Servers 14 may preferably obtain relevant information regarding user evaluations, associated with a Taxicab License Plate 33 or driver 29 via communicating with yet another Database 38 of user generated evaluations. The Database 38 of user generated evaluations, Database 30 with official license plate numbers of registered taxis, and the Database 38 of user generated evaluations may suitably run in Database Servers.

As noted above and depicted in FIG. 1, the Reputation and Notification Servers 14 may communicate with the Taxi User 40 through one of the main devices, including Stand Alone Application 37, Web Application 10, Mobile Application 16, and an SMS enabled mobile phone 20, via the Network 35. An additional option, considered in this Safety System for Taxi Users 40, is to use Email Messages 24 in order to communicate with the Reputation and Notification Servers 14

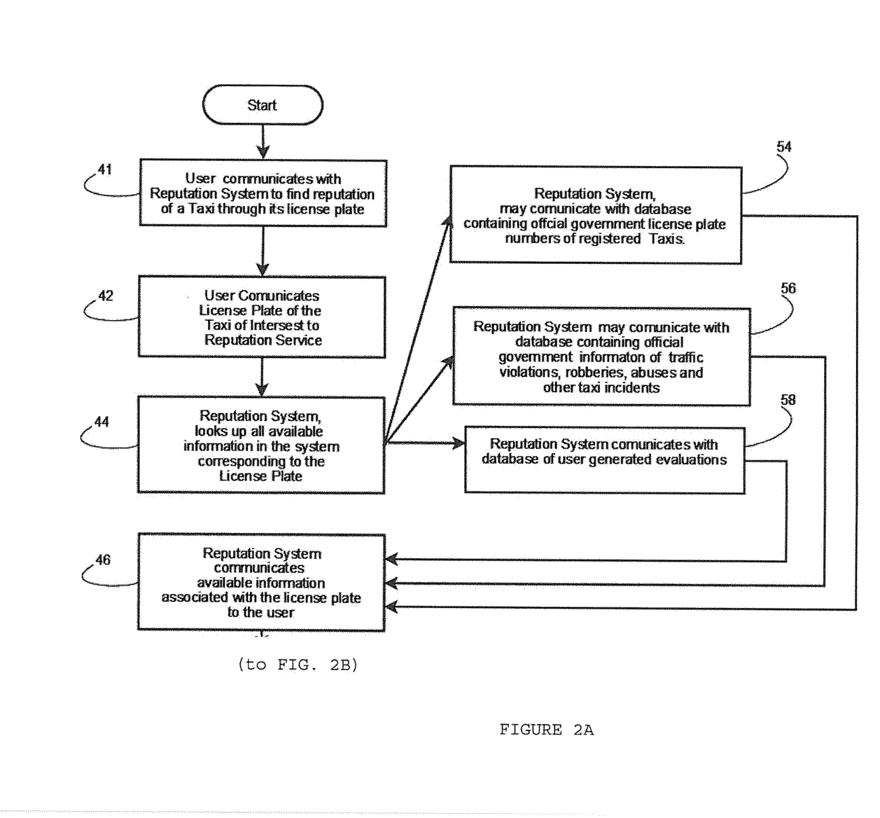

FIG. 2 is a flowchart diagram depicting an embodiment of the workflow of the system of FIG. 1 that a Taxi User may follow when interacting with the System. The flow is outlined below.

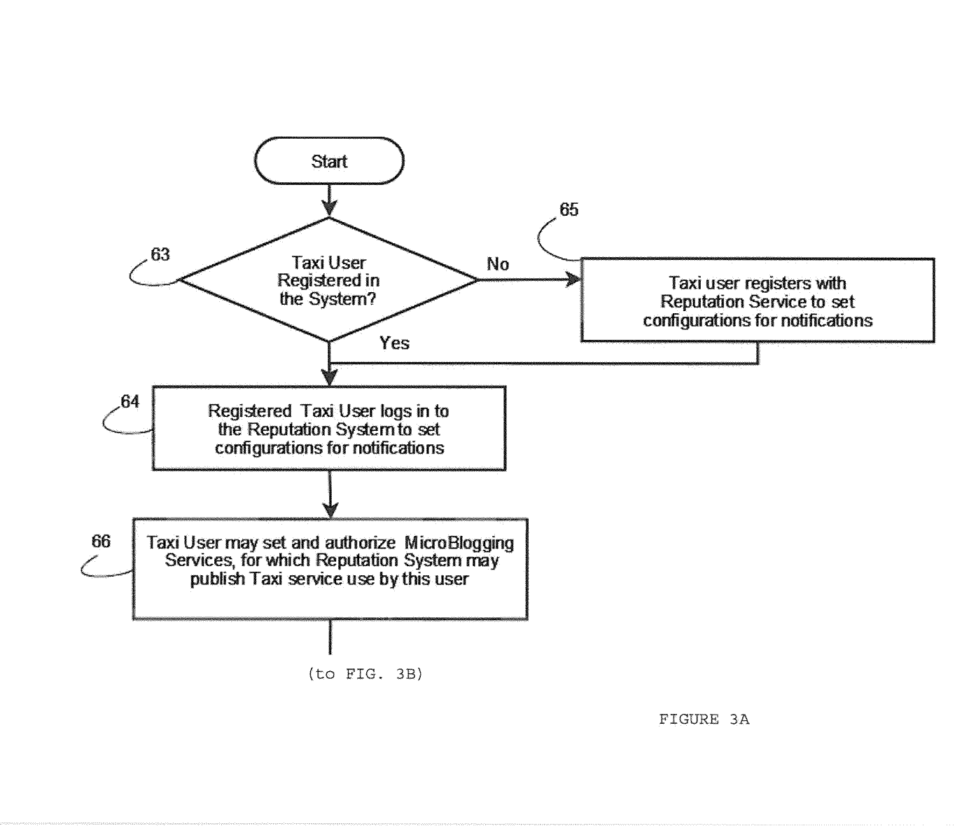

Referring to FIGS. 1 and 2, a Taxi User 40 may first communicate information regarding the license plate 33 of a taxicab 31 (including license plate number, state of license, or country of license) to the Reputation Server 14 via one of the devices (e.g., the Stand Alone Application 37, the Web Application 10, the Mobile Application 16, or the SMS phone 20) that is connected to the network 35. See blocks 41 and 42. In one embodiment, the license plate number may be entered manually via a numeric keyboard. We note FIG. 4 is a preferable software user interface that may be displayed on one of the devices so that the Taxi-user 40 may input the license plate 33 information. In another embodiment the license plate 33 information can be derived mechanically: the license plate 33 number may be input from a picture of the license plate 33 by using Automatic License Plate Recognition (ALPR) (this may be possible when the Network enabled device comes equipped with a camera, as might be the case in a Mobile Application 16); the state and country information (as requested in FIG. 4), can be derived by using internet enabled devices that support and have geo location features activated.

Secondly, the reputation system 14 queries the Database 38 of user generated evaluations, the Database 30 with official license plate numbers of registered taxis, and the Database 38 of user generated evaluations with the license plate 33 information and retrieves data or other information within the respective databases which correlates with the search query. See blocks 44, 54, 56, and 58. As shown in Block 54, the responsive information from the database 30 of official license plate numbers of registered taxis may verify that the Taxicab 31 is or is not a registered vehicle belonging to an authorized Taxicab company. As an additional protection for the Taxi User 40, responsive information from the database 30 may also include the make, model and year of the car to which the Taxicab license plate 33 is officially registered. As shown on block 56, responsive information from the Database 32 with official information regarding traffic violations, robberies, abuses and other incidents involving the taxicab 31 or driver 29. Referring now to block 58, the Reputation and Notification Servers 14 may alternatively or additionally investigate the Database 38 of user generated evaluations after receiving the Taxicab License plate 33 information. In search will return existing information related to the Taxicab license plate 33 to the Reputation and Notification Servers 14.

Third, the responsive data and information retrieved from the database queries, if any, may be communicated to the Taxi-User 40. As illustrated by block 46 of FIG. 2, the Reputation and Notification Servers 14 may preferably deliver responsive information to the Taxi User 40 on the same device used to communicate license plate 33 information to the Reputation and Notification Servers 14 in the earlier steps. For example, if the Taxi User 40 uses a Mobile Application 16 to communicate Taxicab license plate 33 information to the Reputation and Notification Servers 14, the returned information will be communicated to the Taxi User 40 by the Mobile Application 16. For another example if the Taxi User 40 uses a SMS enabled mobile device 20 to communicate a Taxicab license plate 33 to the Reputation and Notification Servers 14, the returned information will be communicated to the Taxi User 40 through the same SMS enabled mobile device 20.

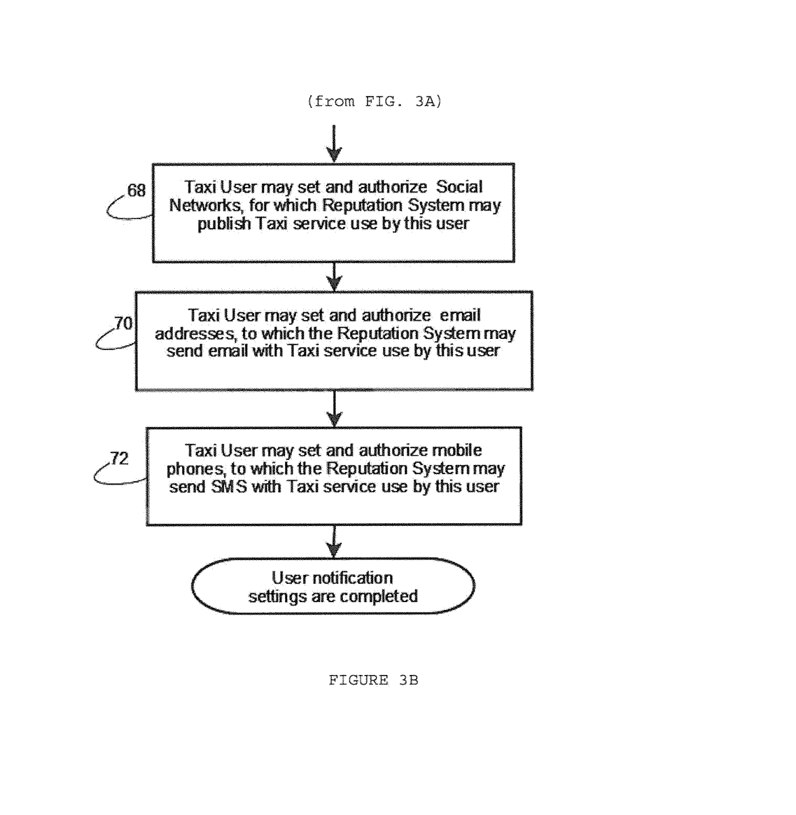

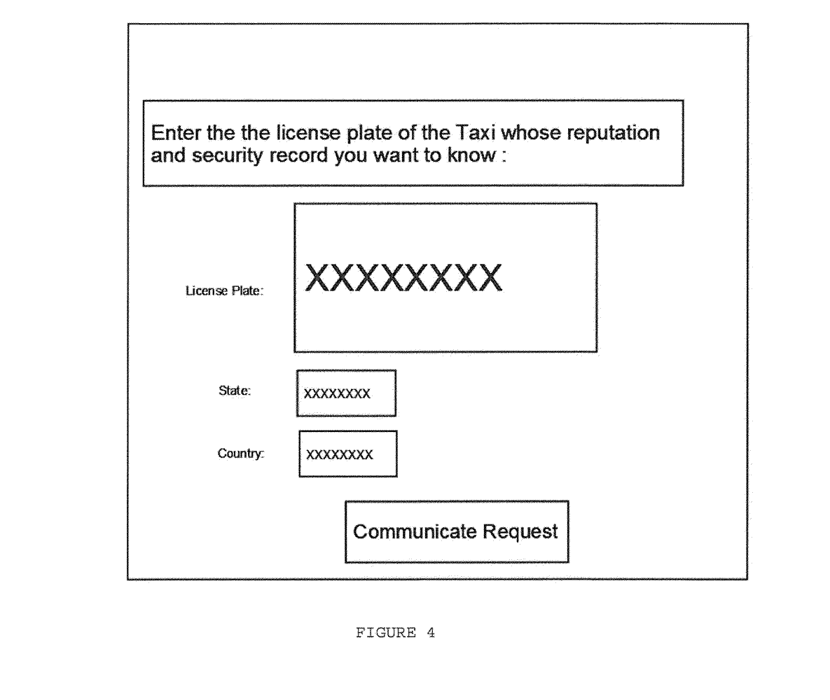

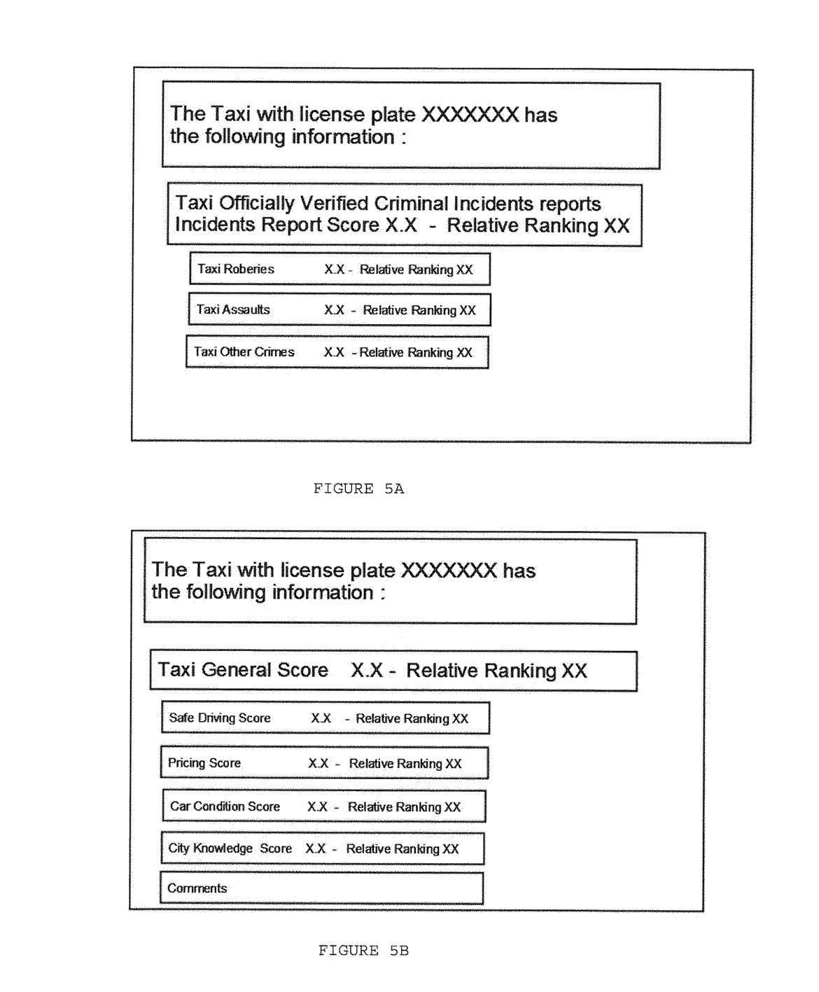

FIG. 5a illustrates a preferable user interface that may be used to communicate responsive information from the Database 32 with official information regarding traffic violations, robberies, abuses and other incidents involving the taxicab 31 or driver 29. In one embodiment, the responsive information the Taxi User 40 may receive is shown in FIG. 5a which may comprise an Officially Verified Criminal Incidents Report. The produced reports may be broken down into such categories as Taxi Robberies, Taxi Assaults, Taxi Other Crimes. Each category may be followed by a number of incidents in the past, as well as relative rankings, compared to other taxis that serve the same area. The relative rankings may be calculated by dividing all registered taxis with incident reports into four buckets. The buckets may be named good, normal, bad, and very bad. Additionally, each bucket will be proportionally limited by a maximum and minimum number of incidents to belong to the bucket. A Taxicab license plate 33 can only be assigned one relative ranking for each category (e.g. Incidents Relative Ranking) and for each subcategory (e.g. Taxi Robberies Relative Ranking).

FIG. 5a illustrates a preferable user interface that may be used to communicate responsive information from the Database 38 of user generated evaluations after receiving the Taxicab License plate 33 information. In one embodiment, the responsive information the Taxi User 40 may receive is shown on FIG. 5b which may comprise User evaluations. The reports shown may be broken down into categories such as Taxi General Score, Taxi Safe Driving Score, Taxi Pricing Score, Taxi Car Condition Score, and Taxi City Knowledge Score. Each of these categories will be followed by a score, as well as relative rankings, compared to other taxis that serve the same area. The relative rankings may be calculated by dividing all evaluated taxis into five buckets. The buckets will be named excellent, good, normal, bad, and very bad. Additionally, each bucket may be proportionally limited by a maximum and minimum number of grade score in order to belong to the bucket. A Taxicab license plate 33 can only be assigned one relative ranking for each category (Taxi General Score) and for each subcategory (e.g. Taxi Pricing Score, Taxi Safe Driving Score).

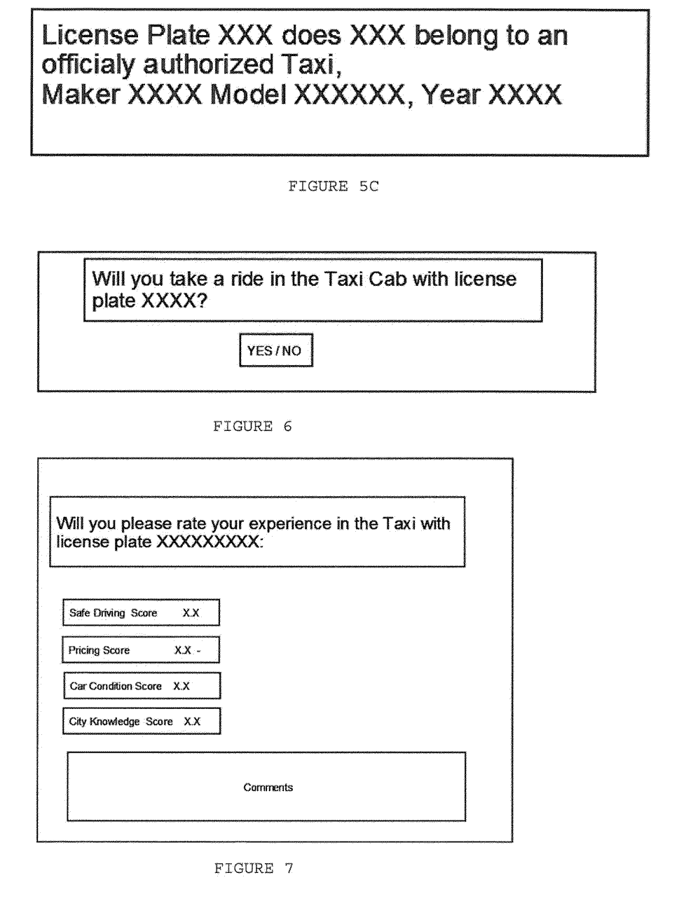

Fourth, after the Taxi User 40 has received the relevant and responsive information (i.e., after Block 46), the Reputation and Notification Servers 14 will ask whether the Taxi 31 with the communicated Taxicab License Plate 33 information will be hired by the Taxi User 40. A typical user interface for the Taxi User 40 to respond to the interrogatory may be shown on FIG. 6. As shown in FIG. 2, IF the Taxi User 40 declines to hire the Taxicab 31, THEN the System ends this specific interaction with the Taxi User 40 ELSE the system 14 may check the notification settings for the Taxi User 40 (See block 49) wherein IF the Taxi User 40 has not registered any notification preferences, THEN the system 14 invites the Taxi User 40 to configure preferences ELSE the Reputation system 14 may, as described in greater detail below, update and publish a notification with the license plate 33 information, time, geo-location of the tax 31 on user social sites 12, micro blogs 36, and email notification accounts 26 AND the Taxi User 40 is invited, as shown on block 52, to leave feedback regarding the experience the User has received while taking the Taxicab 31 with Taxicab license plate 33 information.

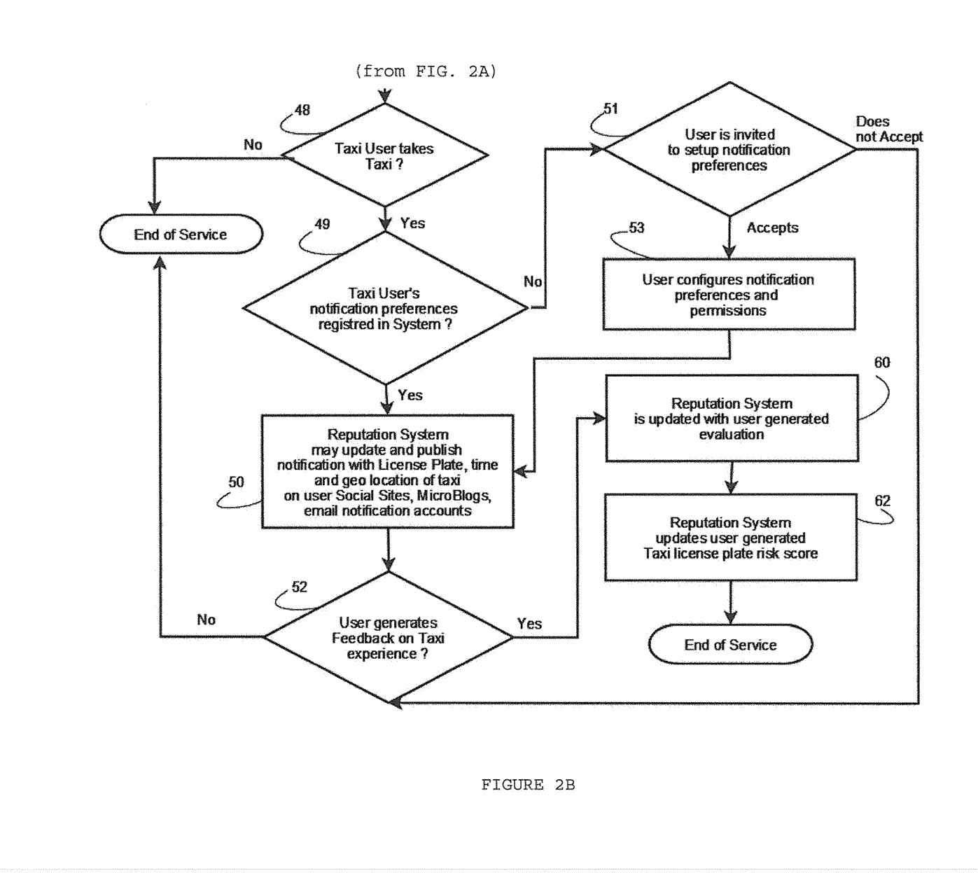

Referring now to the flow chart of FIG. 2 at block 51, FOR every invitation by the system 14 to the Taxi User 40 to configure preferences: If the Taxi User 40 declines to configure the notification preferences at the present moment, THEN the Taxi User 40 is invited, as shown on block 52, to leave feedback regarding the experience the User has received while taking the Taxicab 31 with Taxicab license plate 33 information ELSE the User configures notification preferences and permissions (see block 53) per the flowchart shown in FIG. 3 AND the Reputation system 14 may, as described in greater detail below, update and publish a notification with the license plate 33 information, time, geo-location of the Taxicab 31 on user social sites 12, micro blogs 36, and email notification accounts 26 AND the Taxi User 40 is invited, as shown on block 52, to leave feedback regarding the experience the User has received while taking the Taxicab 31 with Taxicab license plate 33 information.

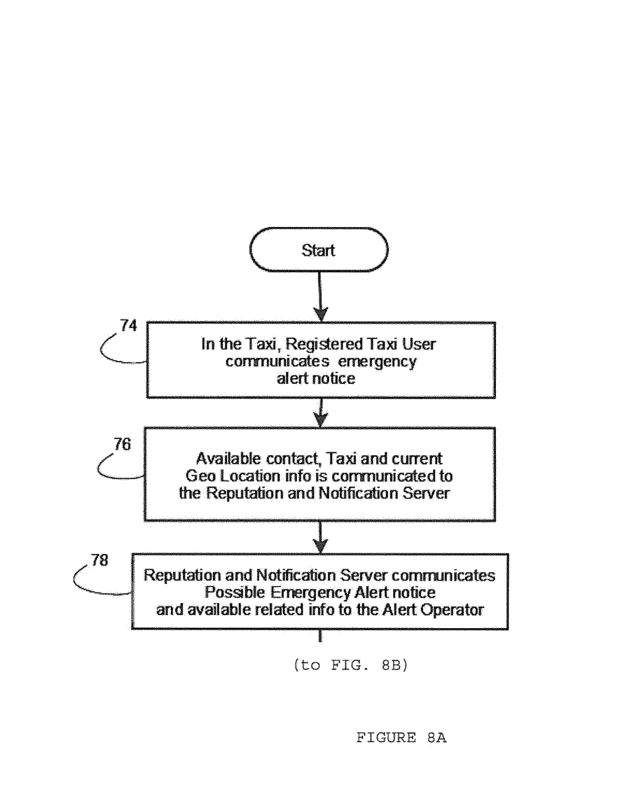

Still Referring to FIG. 2, FOR every invitation to leave feedback (block 52): IF the Taxi User 40 accepts the invention, then the User 40 is prompted to rate various aspects of the User's 40 experience with the Taxi 31 and Driver 29, which ratings may be communicated to the system 14 via the User's device over the network AND the system updates the database 38 of user generated evaluations ELSE service ends. A preferable user interface to be presented to the user 40 for rating the taxi 31 or driver 29 may be depicted in FIG. 7.

Referring once again to The Taxi User 40 can initiate evaluation of the hired Taxicab 31 after sending the Taxicab License Plate 33 information to the Reputation and Notification Servers 14 and requesting to evaluate a Taxicab 31.

The Reputation and Notification Servers 14 will verify that the Taxi User 40 has hired the Taxicab 31 with the Taxicab License Plate number 33 by searching in its operations register for the previous notification by the Taxi User 40 of the existence of the transaction. Then, the Reputation and Notification Servers 14 will authorize the Taxi User 40 to evaluate service, provided by the Cab. The information, communicated for the evaluation, may be what is shown on FIG. 7. That information may include the rating that the Taxi User 40 gave the Taxicab for safe driving. The rating indicates how safely the taxi driver drove. The pricing score indicates if the charged toll matches market prices or previous experiences of the Taxi User. The car condition score indicates if the Taxicab 31 is in a good condition, outside as well as on the inside, and if it has any malfunctions or conditions, which might give indications to the Taxi User 40 that the Taxicab 31 needs maintenance and is not safe. The city knowledge score indicates if the Taxi Driver 29 drove through safe and optimal routes and brought the User to the exact requested destination, without getting lost on the way. The evaluation may include any other information that a Taxi User 14 can rank and that may help to assess the security and quality of the Taxicab 31.

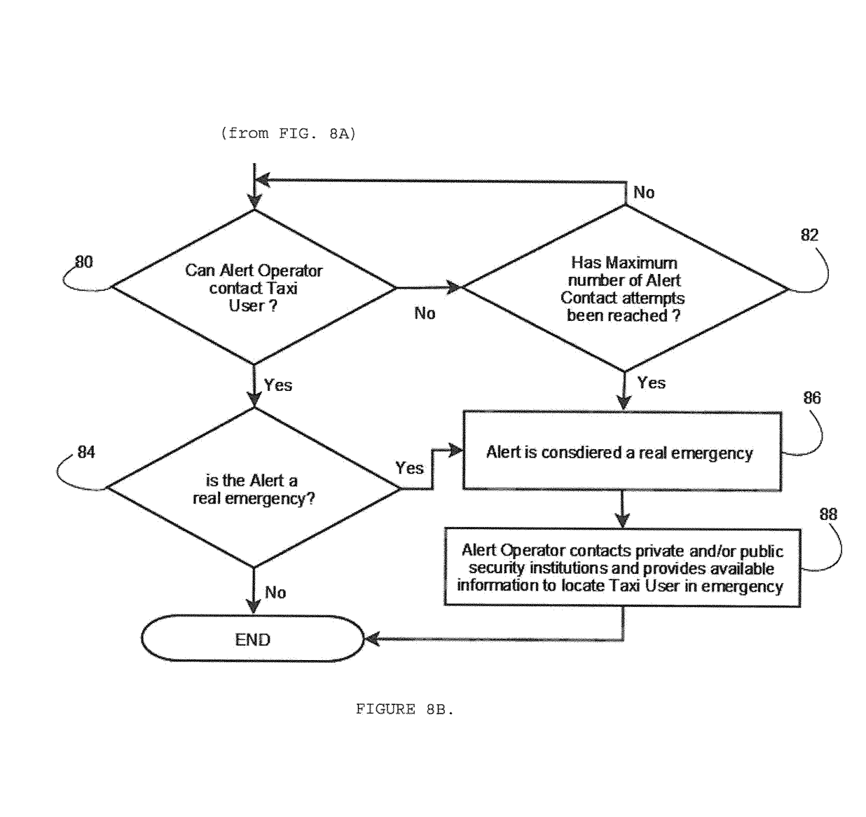

FIG. 8 illustrates a further flow of the system 14 after a Taxi User 40 has hired a taxi 31 and ended service from the flow of FIG. 2. The Taxi User 40 may indicate that he/she has hired the Taxicab 31 and, provided that the Taxi User 40 is registered (as described in FIG. 3) in the System 14 (block 74), the Taxi User 40 may be notified about the possibility to send an emergency alert notice to the System 14. Starting at block 74 of FIG. 8, The Taxi User 40 may initiate the emergency danger alert to communicate to the Reputation and Notification Servers 14 all available information that may help to contact and authenticate the Taxi User 40 (including Geo-location) any available information that may help to identify the Taxi 31 and the Taxi Driver 29 and the available information that may help to identify the location of the Taxi User 40 as shown on block 76. Referring now to block 78, the Alert Operator 27 may be notified of the User's 40 initiation of the emergency notification the corresponding authentication information. After receiving the emergency notification and information, the Alert Operator may attempt to contact the Taxi User 40 via the device, wherein: IF the operator 27 contacts the User 40 AND the alert was not a real emergency, THEN the process ends ELSE the Alert is considered to signify a real emergency AND the operator communicates the emergency and associated information to the public or private security institution 18.

Still referring to FIG. 8, the Reputation and Notification Servers 14 may communicate to the Alert Operator 27 all available or selected information that may assist the Alert Operator 27 to contact and authenticate the Taxi User 40 and determine if an emergency alert is real, wherein the information provided may include name and contact information of the Taxi User 40, as well as the Taxicab license plate 33, secret code phrase, secret alert code phrase and may also include the Geo Location of the electronic device in case the Taxi User 40 is communicating with the Reputation and Notification Servers 14 via a Geo Positioning System (GPS) enabled electronic device. This may be the case when the Taxi User has Mobile Application 16, Stand Alone Application 37, Web Application 10, or other device that has the GPS feature enabled. The Reputation and Notification Servers 14 may enable the Alert Operator 27 to communicate with the Taxi User 40 via the Network 35 on the Taxi User's Mobile Application 16 or Web Application 10 or Stand Alone Application 37 or SMS enabled mobile device 20 or other electronic device. The Alert Operator 27 may suitably attempt to contact the Taxi User 40 as shown on block 80 at least three times, for a period of no longer than two-minutes as shown on block 80, to confirm if the emergency alert is real as shown on block 84. In case the maximum number of contact attempts is reached (i.e., three) as shown on block 82 or a secret alert code is received that confirms that the emergency alert is a real emergency as shown on block 86, the Alert Operator 27 will communicate with Public or Private Security Institutions 18 to notify them that Taxi User 40 is in need of emergency assistance as shown on block 88. The Alert Operator 27 may also preferably communicate to the Security Institutions 18 the Taxi License Plate 33, and, in case the information is available, the Geo Location reported by the Taxi User 40. The Alert Operator 27 may also communicate other available information that can be shared by the Notification and Reputation Servers 14 and that may help the Public or Private Security Institutions 18 to provide safety for the Taxi User 40 as may be information associated to the Taxicab 31, like make, model, and color, or information related to the Taxi Driver 29 (like, for instance, a picture of the Taxi Driver 29 or Taxi Driver License Number). In case the Taxi User 40 verifies that the emergency alert was communicated by accident, the Alert Operator 27 will change the status of the Alert to false and no further action is taken by the Alert Operator 27 as shown on block 84.

FIG. 3 represents a logic flow of the registration or preference configuration of the system by the Taxi User 40. Beginning with FIG. 2 block 51, IF the Taxi User 40 accepts the invitation to configure notification preferences, then Taxi User 40 is directed to the Reputation and Notification Servers 14 and enters the configuring notification preferences flow, illustrated in FIG. 3. First, the Reputation and Notification Servers 14 will verify that the Taxi User 40 is registered in the system, as shown on block 63. This can be done by prompting the Taxi User 40 for his/her unique User ID and password and, after validating that this information is correct, providing access to the Reputation and Notification Servers 14. The User ID can be a mobile phone number, email, screen name or other set of alphanumeric characters. The password can depend on one factor authentication but can also incorporate multi factor authentications, including but not limited to, one time passwords tokens and biometrics. Second, If the Taxi User 40 is not registered in the Reputation and Notification Servers 14, the Taxi User 40 is taken to a registration process, as shown on block 65, wherein the Taxi User 40 may be asked to provide at least a valid User ID, email, mobile phone number and a Password. Once this information is received and validated by the Reputation and Notification Servers 14, the Taxi User 40 will be able to proceed with configuring notifications, as shown on block 64.

In order to set the configuration options for the Micro Blogging, the Taxi User 40 may be offered to publish the Taxicab License Plate 33 of the just hired Taxicab 31 in different micro blogging sites that can include but are not limited to Twitter, Tumblr, Posterous, Dailybooth, Google Buzz or any other site that is a passive broadcast medium in the form of blogging. The Taxi User 40 may suitably provide the information and authentication credentials, required by each individual micro blogging site in order to authorize the Reputation and Notification Servers 14 to publish the Taxicab License Plate 33 information. The Taxi User 40 may elect to provide additional information that can include but is not limited to time, geo location and a Taxi driver 29 picture, among others. The notifications can be published automatically in the Micro Blogging service, or they can be individually prompted for notification authorization every time the Taxi User 40 notifies the Reputation and Notification Servers 14 that the Taxi User has hired a Taxicab 31.

After setting the micro blogging notifications configuration, the next step, as shown on block 68, may be for the Taxi User 40 to be offered the option to configure notifications of the Taxicab License Plate 33 and possibly additional information about the just hired Taxicab 31 in Social Network sites that can include but are not limited to Facebook, MySpace, Hi5, LinkedIn, Orkut, Tuenti or any other web based social network service. The Taxi User 40 will provide the information and authentication credentials, required by each individual web based social network service, in order to authorize the Reputation and Notification Servers 14 to publish the Taxicab License Plate 33 and any additional information the Taxi User 40 may select, which may include but is not limited to time, geo location and a Taxi driver 29 picture, among others. The notifications can be published automatically in the Social Network sites or they can be individually prompted for notification authorization every time the Taxi User 40 notifies the Reputation and Notification Servers 14 that The Taxi User has hired a Taxicab 31.

After setting the Social Networks notifications configuration, the next step, as shown on block 70, may be for the Taxi User 40 to be offered the option to configure notifications of the Taxicab License Plate 33 and possibly additional information of the just hired Taxicab 31 to be sent to selected email accounts. The Taxi User 40 will provide email information of the people, who will be notified via email by the Reputation and Notification Servers 14. The notification message will say that the Taxi User hired the Taxicab 31, with the Taxicab License Plate 33 and will contain any additional information the Taxi User 40 may select, which can include but is not limited to time, geo location and a Taxi driver 29 picture, among others. The notifications can be emailed automatically or they can be individually prompted for notification authorization every time the Taxi User 40 notifies the Reputation and Notification Servers 14 that the User has hired a Taxicab 31.

After setting the email notifications configuration, the next step as shown on block 72, may be for the Taxi User 40 to be offered the option to configure notifications of the Taxicab License Plate 33 and possibly additional information of the just hired Taxicab 31 to be sent to selected SMS enabled phones or other SMS enabled devices. The Taxi User 40 will provide the SMS information of the people, who will be notified via SMS by the Reputation and Notification Servers 14. The notification message will say that the Taxi User hired the Taxicab 31 and will contain additional information the Taxi User 40 may select, which can include but is not limited to time, geo location and a Taxi driver 29 picture among others. The notifications can be sent via SMS automatically or they can be individually prompted for notification authorization every time the Taxi User 40 notifies the Reputation and Notification Servers 14 that the User has hired a Taxicab 31.

Once all or at least one of the notification options are configured, the Taxi User 40 may suitably offered the option to send notifications every time a notification is received by the Reputation and Notification Servers 14, stating that the Taxi User has hired a Taxicab and providing the Taxicab License Plate 33 of the hired Taxicab 31.

The illustrations of the embodiments described herein are intended to provide a general understanding of the structure of the various embodiments. The illustrations are not intended to serve as a complete description of all of the elements and features of apparatus and processors that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and, in some cases, method steps may be performed out of the depicted order. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

In the description, various features may be grouped together or described in a single embodiment for the purpose of streamlining the disclosure. This disclosure is not to be interpreted as reflecting an intention that the claimed embodiments require more features than are expressly recited in each claim. The above disclosed subject matter is to be considered illustrative, and not restrictive.

The inventor of the Safety System for Taxi Users combining reputation mechanisms and community notifications has alternative methods of embodying his invention as described below:
The Safety System for Taxi Users combining reputation mechanisms and community notifications can be used with every type of Taxis as may be, Independent Taxis, Taxi Ranks, Taxi Cooperatives, Hotel Taxis, Airport Taxis
The reputation Safety System for Taxi Users combining reputation mechanisms and community notifications may also be applied to other forms of private and public transportation, as can be commuter vans, vanpoolers, carpoolers, car sharers, trolleys, local and commuter buses.
It is also possible that the reputation of the Taxicab 31 and its service be associated to an identifier other than the Taxicab License Plate 33 as can be Taxi driver name, Taxi Driver License number, Taxi Driver Permit number, Taxi Driver provisional license, Taxicab company or association assigned number, Taxicab permit number, Taxicab provisional permit or license.
The Safety System for Taxi Users combining reputation mechanisms and community notifications can also select as the target of the reputation the Taxicab Driver 29 instead of the Taxicab 31 and its associated Taxicab License Plate 33.
The number of attempted contacts by Alert Operator 27 for contacting a Taxi Users 40 and waiting times can vary in many ranges from 1 to 140000 (or more) attempted contacts, and from no waiting time for an Emergency Alert to be considered confirmed and a security institution notified of the emergency to 72 hours. The elapsed time before each attempted contacts between the Alert Operator 27 and the Taxi User 40 can vary from 0.0001 seconds to 43,200 seconds (or more).
The fields asked to the Taxi User 40 for entering the identifying information of the Taxicab 31 can be limited to only one field that could be the Taxicab License plate 33 or any other taxi identifying information, or be expanded to include many more fields including name of street, cross street, color of taxi, Taxi driver name, Taxi Driver License number, Taxi Driver Permit number, Taxi Driver provisional license, Taxicab company, co-op or association assigned number, Taxicab permit number, Taxicab provisional permit or license.
The number and the order of the screens in which the information is presented can be modified, expanded or collapsed to offer better usability to the Taxi User 40 and to the Alert Operator 27, taking into account among other usability principles Taxi User preferences, electronic device used to communicate with the Reputation and Notification Servers.
The input methods of information for the Taxi User 40 besides including manual text input and pictures can also include video, voice, audio, barcodes.
The reputation returned to the Taxi User 40 may be reduced to displaying only one field, as can be general score for example, to include as many as all the available field stored in the Reputation and Notification Servers 14 and its contents.
The methods and algorithms for maintaining reputations can be a changing combination of one or many different published or non published collaborative or non collaborative trust and reputation mechanisms, that can assign different weights, values and methods to qualitatively or non quantitative data or information to represent trust, mistrust, doubts, security, diffidence, points, karma, first mover effects, normalization, liquidity, quality of service, bias, freshness and decay.
The Taxi User 40 may be offered Altruistic or Sharing Incentives as well as commercial incentives in order to participate in the evaluation of the Taxicab 31 service associated with the Taxicab License Plate 33.
The System for Taxi Users 40 combining reputation mechanisms and community notifications can accept evaluations of verified or non verified Taxi User 40, as well as verified or non verified incident reports.
The Safety System for Taxi Users combining reputation mechanisms and community notifications can incorporate an Abuse reporting mechanism that can incorporate user to user reputation claims as well as user to system. The Safety System for Taxi Users combining reputation mechanisms may also incorporate a mechanism to manually or automatically process claims entered in the Abuse reporting mechanism.
The Safety System for Taxi Users combining reputation mechanisms and community notifications can incorporate inferred reputation submissions as well as just in time reputation calculations.
The Taxicab Driver 33 interacting with the Abuse reporting mechanism may be authenticated into the system incorporating one or multiple factors of authentication.
The reputation can be displayed in many different forms, like stars, emoticons, images provided by site and self uploaded images for example and ranges of values that can be expressed in decimals, real, integers, natural, fractional, positive, negative, imaginary numbers as well as letters like A, B, C, D, F, text or descriptive words like bad, regular, good for example.
The Reputation scores and relative rankings may be calculated using different numerical values and weights to quantifiable and non quantifiable benefits, the resulting values may not be grouped or categorized at all.
The Reputation scores and values that are grouped can be grouped in a range from as little as two categories, like yes or no for example, to as many as 1000 different categories, buckets or ranges. The categories, buckets or ranges may not be proportional in size or number of members per bucket and may use any combination of weight distribution per category or bucket.
The Taxi User 40 may communicate with the Reputation and Notification Servers 14 using one type of client application and receive the answer in one or more different types of client applications than the one used to initiate communications. For example the Taxi User 40 may initiate communications using a Mobile Application and receive the Reputation scores in a Web Application and SMS enabled mobile device.
Fields of the reputation stored in the Reputation and Notification Servers 14 may be categorized as personal, only for logged in users to see. Public visible to the general public or Corporate that will be available only for internal use and not available to the general public.
The order in which the information is requested and presented to the Taxi User 40 can be altered, in as many different combinations as the number of fields for input and output of information are available in Safety System for Taxi Users combining reputation mechanisms and community notifications.
The number of fields considered mandatory information can vary from one to as many as the number of fields for input available in Safety System for Taxi Users combining reputation mechanisms and community notifications.
The Taxi User 40 can use additional client applications to communicate with Reputation and Notification Servers 14 as can be satellite telephones, MMS enabled phone, regular landline phones, or any other device capable of transmitting analog or digital information remotely.
The messages that the user receives can be presented using a wide variety of mediums as is a combination of voice, text or video.
Additional information may be published to micro blogging and social network sites, and may be sent via email or MMS. This information may include any of the information accessible by the Reputation and Notification Servers 14 as can be the text, picture, video, audio of Taxi Driver, or Pictures related to Taxicab or Location. The additional information that may be sent to SMS enabled mobile devices is limited to all the text fields available in the Reputation and Notification Servers 14.
The publication of Notifications in Micro blogging and social network sites as well as the email and SMS messages can be configured for publication in real time or delayed up to a maximum of 72 hours
The Alert Operator 27, after receiving an emergency alert may decide to connect directly with distressed Taxi User 40 by passing the Reputation and Notification Servers 14.
The may be many more categories for Taxi User 40 to evaluate and receive feedback regarding a Taxicab 31, besides Safe Driving Score, Pricing Score, Car Condition Score, City Knowledge Score this additional categories may include Personal security during the day, Personal security during night, Overall comfort of the trip, Cleanliness inside the vehicles, Predictability of travel time, The courtesy of the drivers, The driver understanding directions, Being a good value for the money or any other information that a Taxi User may evaluate and help future Taxi Users 40 assess the Safety of a Taxicab 31.
The Safety System for Taxi Users combining reputation mechanisms and community notifications may process, store and communicate much more detailed information associated to officially verified criminal incidents than only Taxi Robberies, Taxi Assaults, Taxi Other Crimes. The categories may expand to include as many categories as the total number of typified crimes that exist in the law that applies to the municipality, city, county, state and country where the Taxicab License Plate 33 is registered.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

These aspects, among other things, demonstrate the industrial applicability of this invention.

Moreover, it should be apparent that further numerous structural modifications and adaptations may be resorted to without departing from the scope and fair meaning of the present invention as set forth hereinabove and as described herein below by the claims.

Disclosed may be a method for protecting taxi passengers comprising the steps of:
providing a device to a passenger, the device comprising computer and communication hardware coupled to computer readable memory with computer software configured to
   (a) record at least the license plate number of a taxicab and
   (b) communicate the plate number over a network;
providing a server with computer and communication hardware coupled to
   (a) at least one database populated with at least one license plate number associated with a rating of a taxicab service and
   (b) computer readable memory with computer software configured to
      (i) receive a communication from the device containing the license plate number of the taxicab,
      (ii) locate the rating of the taxicab service associated with the license plate number of the taxicab,
      (iii) communicate at least the rating of the taxicab service to the device of the passenger and
      (iv) post the license plate on a social network account of the passenger;
communicating the license plate number to the server from the device;
communicating the associated taxicab rating to the device of the passenger from the server; and,
posting the license plate number on the social network account of the passenger via the server.

I claim:

1. A method for protecting taxi passengers comprising the steps of:
providing a device to a passenger, the device comprising computer and communication hardware coupled to computer readable memory with computer software configured to
(a) record at least the license plate number of a taxicab and
(b) communicate the plate number over a network;
providing a server with computer and communication hardware coupled to
(a) at least one database populated with at least one license plate number associated with a rating of a taxicab service and
(b) computer readable memory with computer software configured to
(i) receive a communication from the device containing the license plate number of the taxicab,
(ii) locate the rating of the taxicab service associated with the license plate number of the taxicab,
(iii) communicate at least the rating of the taxicab service to the device of the passenger and
(iv) post the license plate on a social network account of the passenger;
communicating the license plate number to the server from the device;
communicating the associated taxicab rating to the device of the passenger from the server; and,
posting the license plate number on the social network account of the passenger via the server.
